(19) United States
(12) Patent Application Publication
(10) Pub. No.: US 2021/0101290 A1
(43) Pub. Date: Apr. 8, 2021

(54) APPARATUS FOR COLLECTING ITEM AND CONTROL METHOD THEREOF

(71) Applicant: LG ELECTRONICS INC., Seoul (KR)

(72) Inventor: Soryoung KIM, Seoul (KR)

(73) Assignee: LG ELECTRONICS INC., Seoul (KR)

(21) Appl. No.: 16/732,057

(22) Filed: Dec. 31, 2019

(30) Foreign Application Priority Data
Oct. 2, 2019 (KR) 10-2019-0122560

(51) Int. Cl. B25J 13/00; G06K 9/00

(52) U.S. Cl. CPC B25J 13/006; H04B 1/38; G06K 9/00671

(57) ABSTRACT

At least one of an autonomous vehicle, a user terminal, and a server may be connected or converged with an artificial intelligence (AI) module, an unmanned aerial vehicle (UAV), a robot, an augmented reality (AR) device, a virtual reality (VR) device, a device associated with a 5G service, and the like. A method for a collecting device may include identifying a user and an item associated with the user, identifying image information associated with the user, verifying whether the item is to be collected based on the image information, moving to a position corresponding to the user when the item is to be collected, and providing information associated with item collection to the user.

### CROSS-REFERENCE TO RELATED APPLICATION

Pursuant to 35 U.S.C. § 119(a), this application claims the benefit of earlier filing date and right of priority to Korean Patent Application No. 10-2019-0122560, filed on Oct. 2, 2019, the contents of which are all hereby incorporated by reference herein in its entirety.

### BACKGROUND

### 1. Field

One or more example embodiments of the present disclosure relates to an apparatus for collecting an item and a control method thereof and, more particularly, to an apparatus for identifying an item corresponding to a user based on image information, moving to collect the item, providing related information to the user, and collecting the item, and a control method thereof.

### 2. Description of the Related Art

In a general place, a trash can is located at a fixed position. Also, since it is difficult to sufficiently provide trash cans as many as necessary, a user may move to find a trash can. However, in many cases, location information of the trash can is not guided, so the user may have difficulty in finding the trash can when necessary.

For this reason, garbage is often thrown on the streets and manpower for cleaning is required. Recently, there has been proposed a method of collecting abandoned garbage using a robot moving in a specific area. In this case, however, the robot may be at a predetermined position regardless of a position of the user, and thus may collect garbage after the garbage is thrown to a certain position, which may lead to aesthetic and safety problems.

Accordingly, there is a desire for a method and apparatus for collecting garbage at a desired position of a user and effectively collecting garbage at a point in time when the user is to abandon the garbage.

### SUMMARY

An aspect provides a method and apparatus for effectively collecting an item such as garbage belonging to a user. At least one example embodiment of the present disclosure is to provide a method and apparatus for effectively collecting an item by determining whether a user carries an item to be collected through an image analysis, moving a collecting apparatus to a position corresponding to the user, determining a time at which collection is to be performed, and providing related information.

According to an aspect, there is provided a method for a collecting apparatus, the method including identifying a user and an item associated with the user, identifying image information associated with the user, verifying whether the item is to be collected based on the image information, moving to a position corresponding to the user when the item is to be collected, and providing information associated with item collection to the user.

According to another aspect, there is also provided a collecting apparatus including a transceiver configured to communicate with another node, and a controller configured to control the transceiver and control the collecting apparatus to identify a user and an item associated with the user, identify image information associated with the user, verify whether the item is to be collected based on the image information, move to a position corresponding to the user when the item is to be collected, and provide information associated with item collection to the user.

According to another aspect, there is also provided a server including a transceiver configured to communicate with another node, and a controller configured to control the transceiver and control the server to transmit information on a user and an item associated with the user to a collecting apparatus and receive information associated with the user and collection of the item from the collecting apparatus. The collecting apparatus is configured to collect the item based on image information acquired based on the information on the user and the item.

According to example embodiments, it is possible to identify a user having an item to be collected, move a collecting apparatus to a position corresponding to the user, determine a time at which collection is to be performed, and provide information related to the collection, so that the user easily delivers the item to the collecting apparatus. Through this, it is possible to prevent the item to be collected from being thrown and neglected, and collect the item effectively.

### BRIEF DESCRIPTION OF THE DRAWINGS

The above and other aspects, features, and advantages of certain embodiments will be more apparent from the following detailed description taken in conjunction with the accompanying drawings, in which:

FIG. 1 illustrates an artificial intelligence (AI) device according to an example embodiment;

FIG. 2 illustrates an AI server according to an example embodiment;

FIG. 3 illustrates an AI system according to an example embodiment;

FIG. 4 is a diagram illustrating an operation of controlling a vehicle in response to information being transmitted and received between an operating device and a 5G network according to an example embodiment;

FIG. 5 is a block diagram illustrating a wireless communication system to which a method according to an example embodiment can be applied;

FIG. 6 is a diagram illustrating an example of a method of transmitting and receiving a signal in a wireless communication system according to an example embodiment;

FIG. 7 is a diagram illustrating a collecting apparatus according to an example embodiment;

FIG. 8 is a diagram illustrating a vehicle located in a predetermined section according to an example embodiment;

FIG. 9 is a diagram illustrating an operation of a collecting device in a case in which a user moves between sections according to an example embodiment;

FIG. 10 is a diagram illustrating a method of collecting, by a collecting apparatus, an item according to an example embodiment;

FIG. 11 is a flowchart illustrating information exchanged between item collecting systems and operations of devices based on the information according to an example embodiment;

FIG. 12 is a flowchart illustrating a method of collecting, by a collecting apparatus, an item according to an example embodiment;

FIG. 13 is a flowchart illustrating a method of collecting, by a collecting apparatus, an item according to an example embodiment;

FIG. 14 is a flowchart illustrating a method of collecting, by a collecting apparatus, an item based on at least one piece of image information according to an example embodiment;

FIG. 15 is a flowchart illustrating a method of collecting, by a collecting apparatus, an item based on information on the item and a user according to an example embodiment;

FIG. 16 is a flowchart illustrating a method in which a server of a collection system allocates a collecting apparatus to a section and controls the collecting apparatus according to an example embodiment;

FIG. 17 is a diagram illustrating a collecting apparatus of the present disclosure; and

FIG. 18 is a diagram illustrating a server of the present disclosure.

### DETAILED DESCRIPTION

Embodiments of the disclosure will be described hereinbelow with reference to the accompanying drawings. However, the embodiments of the disclosure are not limited to the specific embodiments and should be construed as including all modifications, changes, equivalent devices and methods, and/or alternative embodiments of the present disclosure. In the description of the drawings, similar reference numerals are used for similar elements.

The terms “have,” “may have,” “include,” and “may include” as used herein indicate the presence of corresponding features (for example, elements such as numerical values, functions, operations, or parts), and do not preclude the presence of additional features.

The terms “A or B,” “at least one of A or/and B,” or “one or more of A or/and B” as used herein include all possible combinations of items enumerated with them. For example, “A or B,” “at least one of A and B,” or “at least one of A or B” means (1) including at least one A, (2) including at least one B, or (3) including both at least one A and at least one B.

The terms such as “first” and “second” as used herein may use corresponding components regardless of importance or an order and are used to distinguish a component from another without limiting the components. These terms may be used for the purpose of distinguishing one element from another element. For example, a first user device and a second user device may indicate different user devices regardless of the order or importance. For example, a first element may be referred to as a second element without departing from the scope the disclosure, and similarly, a second element may be referred to as a first element.

It will be understood that, when an element (for example, a first element) is “(operatively or communicatively) coupled with/to” or “connected to” another element (for example, a second element), the element may be directly coupled with/to another element, and there may be an intervening element (for example, a third element) between the element and another element. To the contrary, it will be understood that, when an element (for example, a first element) is “directly coupled with/to” or “directly connected to” another element (for example, a second element), there is no intervening element (for example, a third element) between the element and another element.

The expression “configured to (or set to)” as used herein may be used interchangeably with “suitable for,” “having the capacity to,” “designed to,” “adapted to,” “made to,” or “capable of” according to a context. The term “configured to (set to)” does not necessarily mean “specifically designed to” in a hardware level. Instead, the expression “apparatus configured to . . . ” may mean that the apparatus is “capable of . . . ” along with other devices or parts in a certain context. For example, “a processor configured to (set to) perform A, B, and C” may mean a dedicated processor (e.g., an embedded processor) for performing a corresponding operation, or a generic-purpose processor (e.g., a central processing unit (CPU) or an application processor (AP)) capable of performing a corresponding operation by executing one or more software programs stored in a memory device.

Exemplary embodiments of the present invention are described in detail with reference to the accompanying drawings.

Detailed descriptions of technical specifications well-known in the art and unrelated directly to the present invention may be omitted to avoid obscuring the subject matter of the present invention. This aims to omit unnecessary description so as to make clear the subject matter of the present invention.

For the same reason, some elements are exaggerated, omitted, or simplified in the drawings and, in practice, the elements may have sizes and/or shapes different from those shown in the drawings. Throughout the drawings, the same or equivalent parts are indicated by the same reference numbers

Advantages and features of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

It will be understood that each block of the flowcharts and/or block diagrams, and combinations of blocks in the flowcharts and/or block diagrams, can be implemented by computer program instructions. These computer program instructions may be provided to a processor of a general-purpose computer, special purpose computer, or other programmable data processing apparatus, such that the instructions which are executed via the processor of the computer or other programmable data processing apparatus create means for implementing the functions/acts specified in the flowcharts and/or block diagrams. These computer program instructions may also be stored in a non-transitory computer-readable memory that can direct a computer or other programmable data processing apparatus to function in a particular manner, such that the instructions stored in the non-transitory computer-readable memory produce articles of manufacture embedding instruction means which implement the function/act specified in the flowcharts and/or block diagrams. The computer program instructions may also be loaded onto a computer or other programmable data processing apparatus to cause a series of operational steps to be performed on the computer or other programmable apparatus to produce a computer implemented process such that the instructions which are executed on the computer or other programmable apparatus provide steps for implementing the functions/acts specified in the flowcharts and/or block diagrams.

Furthermore, the respective block diagrams may illustrate parts of modules, segments, or codes including at least one or more executable instructions for performing specific logic function(s). Moreover, it should be noted that the functions of the blocks may be performed in a different order in several modifications. For example, two successive blocks may be performed substantially at the same time, or may be performed in reverse order according to their functions.

According to various embodiments of the present disclosure, the term “module”, means, but is not limited to, a software or hardware component, such as a Field Programmable Gate Array (FPGA) or Application Specific Integrated Circuit (ASIC), which performs certain tasks. A module may advantageously be configured to reside on the addressable storage medium and be configured to be executed on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and modules may be implemented such that they execute one or more CPUs in a device or a secure multimedia card. An operation of a component described as a vehicle in an example embodiment may be performed by an operating device associated with a collecting apparatus. The collecting apparatus may be embodied in a form of, for example, a robot and a vehicle. It is obvious that the collecting apparatus may include a structure corresponding to an item collected from a user.

In addition, a controller mentioned in the embodiments may include at least one processor that is operated to control a corresponding apparatus. An operation of a constituent element described as a vehicle may be performed by an operating apparatus related to the vehicle.

Artificial Intelligence refers to the field of studying artificial intelligence or a methodology capable of making the artificial intelligence. Machine learning refers to the field of studying methodologies that define and solve various problems handled in the field of artificial intelligence. Machine learning is also defined as an algorithm that enhances the performance of a task through a steady experience with respect to the task.

An artificial neural network (ANN) is a model used in machine learning, and may refer to a general model that is composed of artificial neurons (nodes) forming a network by synaptic connection and has problem solving ability. The artificial neural network may be defined by a connection pattern between neurons of different layers, a learning process of updating model parameters, and an activation function of generating an output value.

The artificial neural network may include an input layer and an output layer, and may selectively include one or more hidden layers. Each layer may include one or more neurons, and the artificial neural network may include a synapse that interconnects neurons. In the artificial neural network, each neuron may output input signals that are input through the synapse, weights, and the value of an activation function concerning deflection.

Model parameters refer to parameters determined by learning, and include weights for synaptic connection and deflection of neurons, for example. Then, hyper-parameters mean parameters to be set before learning in a machine learning algorithm, and include a learning rate, the number of repetitions, the size of a mini-batch, and an initialization function, for example.

It can be said that the purpose of learning of the artificial neural network is to determine a model parameter that minimizes a loss function. The loss function maybe used as an index for determining an optimal model parameter in a learning process of the artificial neural network.

Machine learning may be classified, according to a learning method, into supervised learning, unsupervised learning, and reinforcement learning.

The supervised learning refers to a learning method for an artificial neural network in the state in which a label for learning data is given. The label may refer to a correct answer (or a result value) to be deduced by an artificial neural network when learning data is input to the artificial neural network. The unsupervised learning may refer to a learning method for an artificial neural network in the state in which no label for learning data is given. The reinforcement learning may mean a learning method in which an agent defined in a certain environment learns to select a behavior or a behavior sequence that maximizes cumulative compensation in each state.

Machine learning realized by a deep neural network (DNN) including multiple hidden layers among artificial neural networks is also called deep learning, and deep learning is a part of machine learning. Hereinafter, machine learning is used as a meaning including deep learning.

The term “autonomous driving” refers to a technology of autonomous driving, and the term “autonomous vehicle” refers to a vehicle that travels without a user's operation or with a user's minimum operation.

For example, autonomous driving may include all of a technology of maintaining the lane in which a vehicle is driving, a technology of automatically adjusting a vehicle speed such as adaptive cruise control, a technology of causing a vehicle to automatically drive along a given route, and a technology of automatically setting a route, along which a vehicle drives, when a destination is set.

At this time, an autonomous vehicle may be seen as a robot having an autonomous driving function.

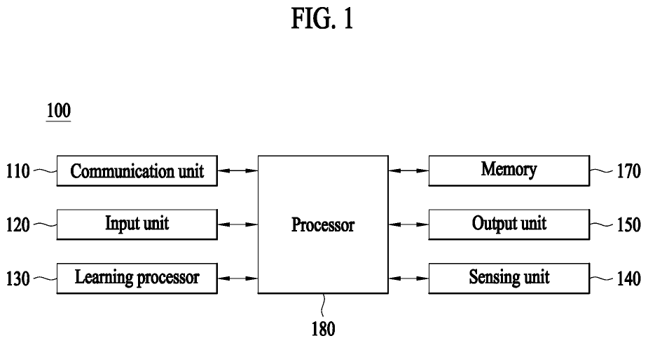

FIG. 1 illustrates an AI device 100 according to an embodiment of the present disclosure.

AI device 100 may be realized into, for example, a stationary appliance or a movable appliance, such as a TV, a projector, a cellular phone, a smart phone, a desktop computer, a laptop computer, a digital broadcasting terminal, a personal digital assistant (PDA), a portable multimedia player (PMP), a navigation system, a tablet PC, a wearable device, a set-top box (STB), a DMB receiver, a radio, a washing machine, a refrigerator, a digital signage, a robot, or a vehicle. The AI device may include an operating apparatus related to at least one of a vehicle or a server.

Referring to FIG. 1, Terminal 100 may include a communication unit 110, an input unit 120, a learning processor 130, a sensing unit 140, an output unit 150, a memory 170, and a processor 180, for example.

Communication unit 110 may transmit and receive data to and from external devices, such as other AI devices 100a to 100e and an AI server 200, using wired/wireless communication technologies. For example, communication unit 110 may transmit and receive sensor information, user input, learning models, and control signals, for example, to and from external devices.

In this case, the communication technology used by communication unit 110 may be, for example, a global system for mobile communication (GSM), code division multiple Access (CDMA), long term evolution (LTE), 5G, wireless LAN (WLAN), wireless-fidelity (Wi-Fi), Bluetooth™, radio frequency identification (RFID), infrared data association (IrDA), ZigBee, or near field communication (NFC).

Input unit 120 may acquire various types of data.

In this case, input unit 120 may include a camera for the input of an image signal, a microphone for receiving an audio signal, and a user input unit for receiving information input by a user, for example. Here, the camera or the microphone may be handled as a sensor, and a signal acquired from the camera or the microphone may be referred to as sensing data or sensor information.

Input unit 120 may acquire, for example, input data to be used when acquiring an output using learning data for model learning and a learning model. Input unit 120 may acquire unprocessed input data, and in this case, processor 180 or learning processor 130 may extract an input feature as pre-processing for the input data.

Learning processor 130 may cause a model configured with an artificial neural network to learn using the learning data. Here, the learned artificial neural network may be called a learning model. The learning model may be used to deduce a result value for newly input data other than the learning data, and the deduced value may be used as a determination base for performing any operation.

In this case, learning processor 130 may perform AI processing along with a learning processor 240 of AI server 200.

In this case, learning processor 130 may include a memory integrated or embodied in AI device 100. Alternatively, learning processor 130 may be realized using memory 170, an external memory directly coupled to AI device 100, or a memory held in an external device. The AI device 100 may be related to the vehicle and may perform an operation required for resource management of the vehicle.

Sensing unit 140 may acquire at least one of internal information of AI device 100 and surrounding environmental information and user information of AI device 100 using various sensors.

In this case, the sensors included in sensing unit 140 may be a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar, for example.

Output unit 150 may generate, for example, a visual output, an auditory output, or a tactile output.

In this case, output unit 150 may include, for example, a display that outputs visual information, a speaker that outputs auditory information, and a haptic module that outputs tactile information.

Memory 170 may store data which assists various functions of AI device 100. For example, memory 170 may store input data acquired by input unit 120, learning data, learning models, and learning history, for example.

Processor 180 may determine at least one executable operation of AI device 100 based on information determined or generated using a data analysis algorithm or a machine learning algorithm. Then, processor 180 may control constituent elements of AI device 100 to perform the determined operation.

To this end, processor 180 may request, search, receive, or utilize data of learning processor 130 or memory 170, and may control the constituent elements of AI device 100 so as to execute a predictable operation or an operation that is deemed desirable among the at least one executable operation.

In this case, when connection of an external device is necessary to perform the determined operation, processor 180 may generate a control signal for controlling the external device and may transmit the generated control signal to the external device.

Processor 180 may acquire intention information with respect to user input and may determine a user request based on the acquired intention information.

In this case, processor 180 may acquire intention information corresponding to the user input using at least one of a speech to text (STT) engine for converting voice input into a character string and a natural language processing (NLP) engine for acquiring natural language intention information.

In this case, at least a part of the STT engine and/or the NLP engine may be configured with an artificial neural network learned according to a machine learning algorithm. Then, the STT engine and/or the NLP engine may have learned by learning processor 130, may have learned by learning processor 240 of AI server 200, or may have learned by distributed processing of processors 130 and 240.

Processor 180 may collect history information including, for example, the content of an operation of AI device 100 or feedback of the user with respect to an operation, and may store the collected information in memory 170 or learning processor 130, or may transmit the collected information to an external device such as AI server 200. The collected history information may be used to update a learning model.

Processor 180 may control at least some of the constituent elements of AI device 100 in order to drive an application program stored in memory 170. Moreover, processor 180 may combine and operate two or more of the constituent elements of Al device 100 for the driving of the application program.

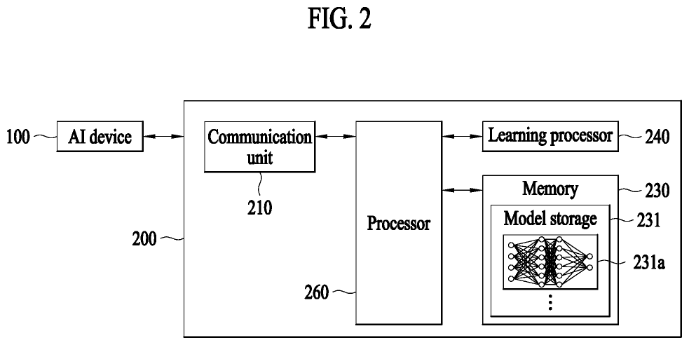

FIG. 2 illustrates AI server 200 according to an embodiment of the present disclosure.

Referring to FIG. 2, AI server 200 may refer to a device that causes an artificial neural network to learn using a machine learning algorithm or uses the learned artificial neural network. Here, AI server 200 may be constituted of multiple servers to perform distributed processing, and may be defined as a 5G network. In this case, AI server 200 may be included as a constituent element of AI device 100 so as to perform at least a part of AI processing together with AI device 100.

AI server 200 may include a communication unit 210, a memory 230, a learning processor 240, and a processor 260, for example.

Communication unit 210 may transmit and receive data to and from an external device such as AI device 100.

Memory 230 may include a model storage unit 231. Model storage unit 231 may store a model (or an artificial neural network) 231a which is learning or has learned via learning processor 240.

Learning processor 240 may cause artificial neural network 231a to learn learning data. A learning model may be used in the state of being mounted in AI server 200 of the artificial neural network, or may be used in the state of being mounted in an external device such as AI device 100.

The learning model may be realized in hardware, software, or a combination of hardware and software. In the case in which a part or the entirety of the learning model is realized in software, one or more instructions constituting the learning model may be stored in memory 230.

Processor 260 may deduce a result value for newly input data using the learning model, and may generate a response or a control instruction based on the deduced result value.

The AI server may include a server that generates a VM related to the vehicle and drives the VM. The server may perform learning based on data on generation and driving of the VM, and perform an operation to optimize such learning process.

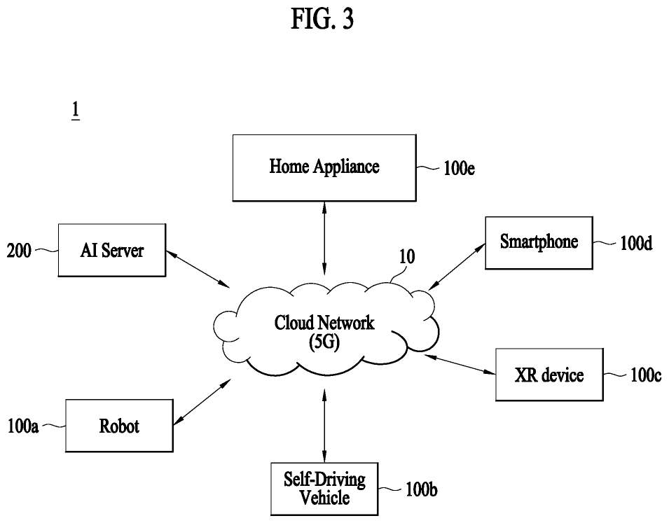

FIG. 3 illustrates an AI system 1 according to an embodiment of the present disclosure.

Referring to FIG. 3, in AI system 1, at least one of AI server 200, a robot 100a, an autonomous driving vehicle 100b, an XR device 100c, a smart phone 100d, and a home appliance 100e is connected to a cloud network 10. Here, robot 100a, autonomous driving vehicle 100b, XR device 100c, smart phone 100d, and home appliance 100e, to which AI technologies are applied, may be referred to as AI devices 100a to 100e.

Cloud network 10 may constitute a part of a cloud operating infra-structure, or may mean a network present in the cloud operating infra-structure. Here, cloud network 10 may be configured using a 3G network, a 4G or long term evolution (LTE) network, or a 5G network, for example.

That is, respective devices 100a to 100e and 200 constituting AI system 1 may be connected to each other via cloud network 10. In particular, respective devices 100a to 100e and 200 may communicate with each other via a base station, or may perform direct communication without the base station.

AI server 200 may include a server which performs AI processing and a server which performs an operation with respect to big data.

AI server 200 may be connected to at least one of robot 100a, autonomous driving vehicle 100b, XR device 100c, smart phone 100d, and home appliance 100e, which are AI devices constituting AI system 1, via cloud network 10, and may assist at least a part of AI processing of connected AI devices 100a to 100e.

In this case, instead of AI devices 100a to 100e, AI server 200 may cause an artificial neural network to learn according to a machine learning algorithm, and may directly store a learning model or may transmit the learning model to AI devices 100a to 100e.

In this case, AI server 200 may receive input data from AI devices 100a to 100e, may deduce a result value for the received input data using the learning model, and may generate a response or a control instruction based on the deduced result value to transmit the response or the control instruction to AI devices 100a to 100e.

Alternatively, AI devices 100a to 100e may directly deduce a result value with respect to input data using the learning model, and may generate a response or a control instruction based on the deduced result value.

Hereinafter, various embodiments of AI devices 100a to 100e, to which the above-described technology is applied, will be described. Here, AI devices 100a to 100e illustrated in FIG. 3 may be specific embodiments of AI device 100 illustrated in FIG. 1.

Autonomous driving vehicle 100b may be realized into a mobile robot, a vehicle, or an unmanned air vehicle, for example, through the application of AI technologies.

Autonomous driving vehicle 100b may include an autonomous driving control module for controlling an autonomous driving function, and the autonomous driving control module may mean a software module or a chip realized in hardware. The autonomous driving control module may be a constituent element included in autonomous driving vehicle 100b, but may be a separate hardware element outside autonomous driving vehicle 100b so as to be connected to autonomous driving vehicle 100b.

Autonomous driving vehicle 100b may acquire information on the state of autonomous driving vehicle 100b using sensor information acquired from various types of sensors, may detect (recognize) the surrounding environment and an object, may generate map data, may determine a movement route and a driving plan, or may determine an operation.

Here, autonomous driving vehicle 100b may use sensor information acquired from at least one sensor among a lidar, a radar, and a camera in the same manner as robot 100a in order to determine a movement route and a driving plan.

In particular, autonomous driving vehicle 100b may recognize the environment or an object with respect to an area outside the field of vision or an area located at a predetermined distance or more by receiving sensor information from external devices, or may directly receive recognized information from external devices.

Autonomous driving vehicle 100b may perform the above-described operations using a learning model configured with at least one artificial neural network. For example, autonomous driving vehicle 100b may recognize the surrounding environment and the object using the learning model, and may determine a driving line using the recognized surrounding environment information or object information. Here, the learning model may be directly learned in autonomous driving vehicle 100b, or may be learned in an external device such as AI server 200.

In this case, autonomous driving vehicle 100b may generate a result using the learning model to perform an operation, but may transmit sensor information to an external device such as AI server 200 and receive a result generated by the external device to perform an operation.

Autonomous driving vehicle 100b may determine a movement route and a driving plan using at least one of map data, object information detected from sensor information, and object information acquired from an external device, and a drive unit may be controlled to drive autonomous driving vehicle 100b according to the determined movement route and driving plan.

The map data may include object identification information for various objects arranged in a space (e.g., a road) along which autonomous driving vehicle 100b drives. For example, the map data may include object identification information for stationary objects, such as streetlights, rocks, and buildings, and movable objects such as vehicles and pedestrians. Then, the object identification information may include names, types, distances, and locations, for example.

In addition, autonomous driving vehicle 100b may perform an operation or may drive by controlling the drive unit based on user control or interaction. In this case, autonomous driving vehicle 100b may acquire interactional intention information depending on a user operation or voice expression, and may determine a response based on the acquired intention information to perform an operation.

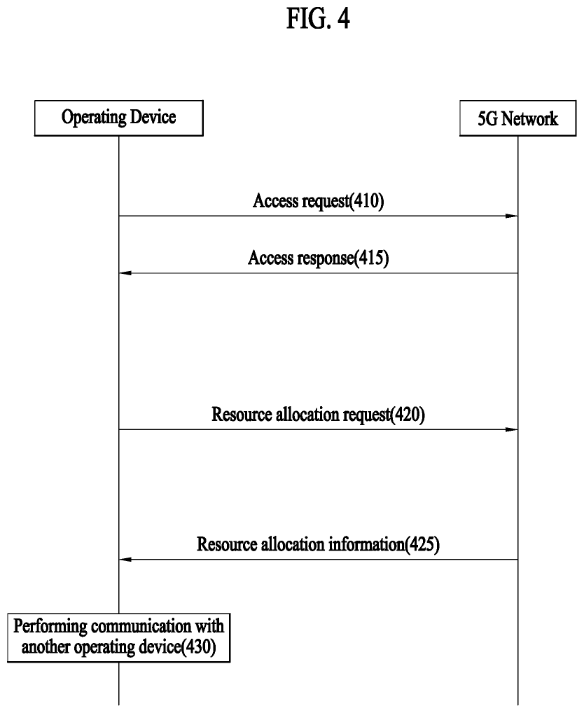

FIG. 4 is a diagram illustrating an operation of controlling a vehicle in response to information being transmitted and received between an operating device and a 5G network according to an example embodiment.

FIG. 4 illustrates a communication method performed between an operating device and a 5G network. In the example embodiment, the operating device may be included in an apparatus for collecting an item. For example, the operating device may be included in a robot for collecting an item.

In operation 410, the operating device may transmit an access request to the 5G network. The access request may be received by a base station and transmitted on a channel for transmitting an access request. The access request may include information for identifying the operating device.

In operation 415, the 5G network may transmit a response to the access request to the operating device. The response to the access request, for example, an access response, may include identification information to be used when the operating device receives information. Also, the access response may include wireless resource allocation information for transmitting and receiving information of the operating device.

In operation 420, the operating device may transmit a wireless resource allocation request for communicating with another device or a base station based on the received information. The wireless resource allocation request may include at least one of information on an operating device and information on a counterpart node for performing communication.

In operation 425, the 5G network may transmit wireless resource allocation information to the operating device. The wireless resource allocation information may be determined based on at least a portion of the information transmitted in operation 420. For example, information associated with resources allocated to communicate with another operating device and identification information to be used for the corresponding communication may be included in the wireless resource allocation information. For example, communication with another operating device may be performed on a channel for device-to-device communication.

In operation 430, the operating device may perform communication with another operating device based on the received information.

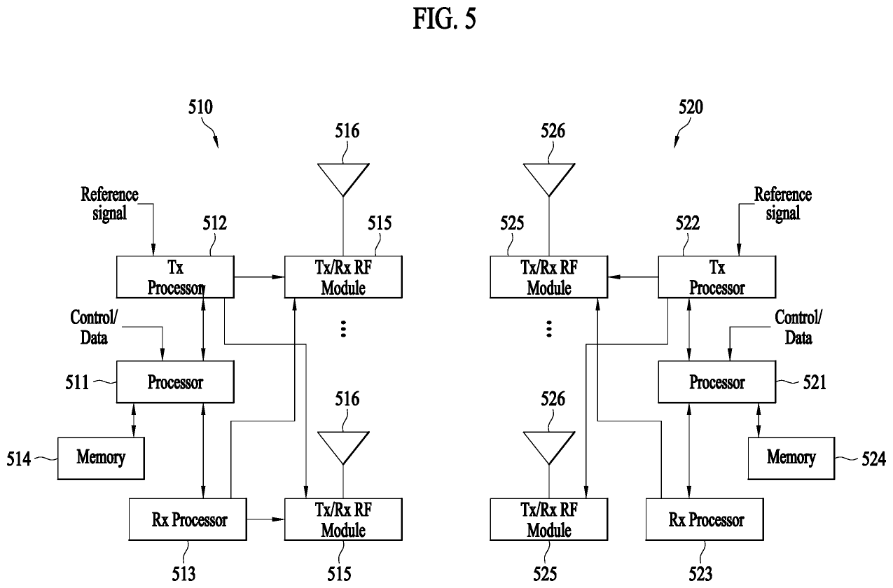

FIG. 5 is a block diagram of a wireless communication system to which a method according to an embodiment of the present disclosure can be applied.

Referring to FIG. 5, an apparatus (an autonomous driving apparatus) including an autonomous driving module may be defined as a first communication device 510, and a processor 511 may perform detailed autonomous driving operations.

A 5G network including another vehicle capable of communicating with the autonomous driving apparatus may be defined as a second communication device 520, and a processor 521 may perform detailed autonomous driving operations.

The 5G network may be expressed as a first communication device, and the autonomous driving apparatus may be expressed as a second communication device.

For example, the first communication device or the second communication device may be a base station, a network node, a Tx terminal, an Rx terminal, a wireless device, a wireless communication device, an autonomous driving apparatus, etc.

For example, a terminal or User Equipment (UE) may include a vehicle, a mobile phone, a smart phone, a laptop computer, a personal digital assistant (PDA), a portable multimedia player (PMP), a navigation, a slate PC, a tablet PC, an ultrabook, a wearable device (e.g., a smartwatch, a smart glass, a head mounted display (HMD)), etc. The HMD may be a display device which can be worn on a user's head. For example, the HMD may be used to realize virtual reality (VR), augmented reality (AR), and mixed reality (MR). Referring to FIG. 1, the first communication device 510 and the second communication device 520 includes processors 511 and 521, memories 514 and 524, one or more Tx/Rx radio frequency (RF) modules 515 and 525, Tx processors 512 and 522, Rx processors 513 and 523, and antennas 516 and 526. A Tx/Rx module may be referred to as transceivers. Each Tx/RX module transmits a signal through the antenna 526. The processor performs the above-described functions, processes, and/or methods. The processor 521 may be related to the memory 524 for storing program codes and data. The memory may be referred to as a computer readable medium. More specifically, in the DL (communication from the first communication device to the second communication), the Tx processor 512 implements various signal processing functions of L1 layer (that is, physical layer). The Rx processor implements various signal processing functions of the L1 layer (that is, physical layer).

The UL (communication from the second communication device to the first communication device) is implemented in the first communication device 510 in a manner similar to the above-description regarding receiver functions in the second communication device 520. Each Tx/Rx module 525 may receive a signal through the antenna 526. Each Tx/Rx module provides a RF subcarrier and information to the Rx processor 523. The processor 521 may be related to the memory 524 for storing program codes and data. The memory may be referred to as a computer readable medium.

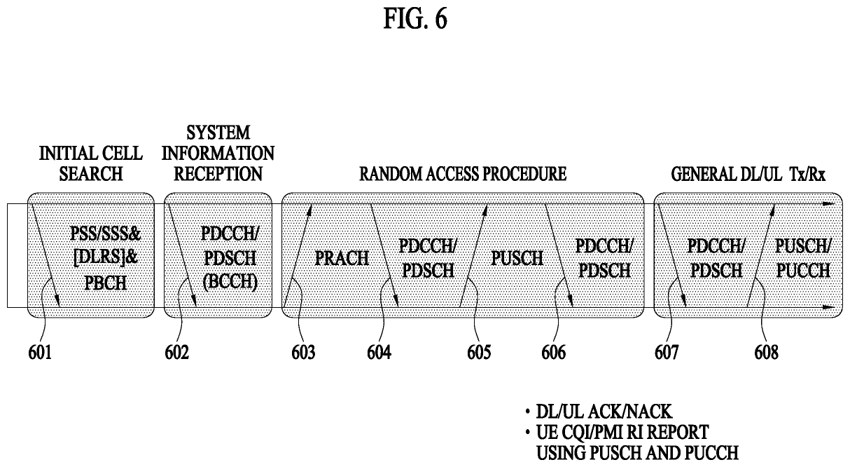

FIG. 6 is a diagram illustrating a method of transmitting and receiving a signal in a wireless communication system according to an example embodiment.

FIG. 6 illustrates an example of a signal transmission/reception method in a wireless communication system.

Referring to FIG. 6, when UE is powered on or enters a new cell, the UE may perform initial cell search such as synchronization with a BS (601). To this end, the UE may receive a primary synchronization channel (P-SCH) and a secondary synchronization channel (S-SCH) from the BS to synchronize with the BS, and may acquire information such as a cell ID. In an LTE system and an NR system, the P-SCH and the S-SCH may be called a primary synchronization signal (PSS) and a secondary synchronization signal (SSS), respectively. After the initial cell search, the UE may acquire broadcast information in the cell by receiving a physical broadcast channel (PBCH) from the BS. Meanwhile, the UE may check the state of a downlink channel by receiving a downlink reference signal (DL RS) during the initial cell search. After completing the initial cell search, the UE may acquire more specific system information by receiving a physical downlink control channel (PDCCH) and a physical downlink shared channel (PDSCH) based on information on the PDCCH (602).

When the UE initially accesses the BS or when there is no radio resource for signal transmission, the UE may perform a random access procedure (RACH) for the BS (603 to 606). To this end, the UE may transmit a specific sequence as a preamble through a physical random access channel (PRACH) (603 and 605), and may receive a random access response (RAR) message for the preamble through the PDCCH and the PDSCH (604 and 606). In the case of contention-based RACH, the UE may additionally perform a contention resolution procedure.

After performing the above-described procedure, the UE may perform, as general uplink/downlink signal transmission procedures, PDCCH/PDSCH reception (607) and physical uplink shared channel (PUSCH)/physical uplink control channel (PUCCH) transmission (208). In particular, the UE may receive downlink control information (DCI) through the PDCCH. The UE may monitor a set of PDCCH candidates at monitoring occasions which are set in one or more control element sets (CORESETs) on a serving cell according to search space configurations. The set of PDCCH candidates to be monitored by the UE may be defined in terms of search space sets, and such a search space set may be a common search space set or a UE-specified search space set. The CORESET is composed of a set of (physical) resource blocks having a time duration of 1 to 3 OFDM symbols. The network may set the UE to have multiple CORESETs. The UE may monitor PDCCH candidates in one or more search space sets. Here, monitoring may refer to attempting to decode PDCCH candidate(s) in a search space. When the UE has succeeded in decoding one of the PDCCH candidates in the search space, the UE may determine that a PDCCH has been detected in a PDCCH candidate, and may perform PDSCH reception or PUSCH transmission based on DCI on the detected PDCCH. The PDCCH may be used to schedule DL transmissions through the PDSCH and UL transmissions through the PUSCH. Here, the DCI on the PDCCH may include downlink assignment (i.e., downlink (DL) grant) including at least modulation, coding format, and resource allotment information associated with a downlink shared channel or uplink (UL) grant including modulation, coding format, and resource allotment information associated with an uplink shared channel.

Referring to FIG. 6, initial access (IA) in the 5G communication system will be further described.

The UE may perform cell search, system information acquisition, beam alignment for initial access, and DL measurement based on an SSB. The SSB may be mixed with a synchronization signal/physical broadcast channel (SS/PBCH) block.

The SSB may be composed of a PSS, an SSS, and a PBCH. The SSB may be composed of four consecutive OFDM symbols, and the PSS, PBCH, SSS/PBCH, or PBCH may be transmitted for each OFDM symbol. Each of the PSS and SSS may be composed of 1 OFDM symbol and 127 subcarriers, and the PBCH may be composed of 3 OFDM symbols and 576 subcarriers.

The cell search may refer to a procedure in which the UE acquires time/frequency synchronization of a cell and detects a cell identifier (ID) (e.g., a physical layer cell ID (PCI)) of the cell. The PSS may be used to detect a cell ID in a cell ID group, and the SSS may be used to detect the cell ID group. The PBCH may be used for SSB (time) index detection and half-frame detection.

There may be 336 cell ID groups, and three cell IDs may exist for each cell ID group. Thus, a total of 1008 cell IDs may exist. Information on a cell ID group, to which a cell ID of a cell belongs, may be provided or acquired through the SSS of the cell, and information on a cell ID among cell IDs of 336 cell ID groups may be provided or acquired through the PSS.

The SSB may be transmitted periodically based on the periodicity of the SSB. An SSB basic period assumed by the UE at the time of initial cell search may be defined as 20 ms. After the cell access, the periodicity of the SSB may be set to one of 5 ms, 10 ms, 20 ms, 40 ms, 80 ms, and 160 ms by a network (e.g., BS).

Next, acquisition of system information (SI) will be described.

The SI may include a master information block (MIB) and multiple system information blocks (SIBs). The SI other than the MIB may be referred to as remaining minimum system Information (RMSI). The MIB may include information/parameters for monitoring the PDCCH which schedules the PDSCH carrying system information block 1 (SIB1), and may be transmitted by the BS through the PBCH of the SSB. The SIB1 may include information on the availability and scheduling (e.g., a transmission period and an SI-window size) of the remaining SIBs (hereinafter, SIBx (x being an integer of 2 or more)). The SIBx may be included in an SI message and may be transmitted through the PDSCH. Each SI message may be transmitted within a time window (i.e., an SI-window) which periodically occurs.

Referring to FIG. 6, random access (RA) in the 5G communication system will be further described.

The random access may be used for various purposes. For example, the random access may be used for network initial access, handover, and UE-triggered UL data transmission. The UE may acquire UL synchronization and UL transmission resources through the random access. The random access may be classified into contention-based random access and contention-free random access. A detailed procedure for the contention-based random access is as follows.

The UE may transmit a random access preamble as an Msg1 of the random access in UL through the PRACH. Random access preamble sequences having two different lengths may be supported. A Long sequence length of 839 may be applied to a subcarrier spacing of 1.25 kHz or 5 kHz, and a short sequence length of 139 may be applied to a subcarrier spacing of 15 kHz, 30 kHz, 60 kHz, or 120 kHz.

When the BS receives the random access preamble from the UE, the BS may transmit a random access response (RAR) message (Msg2) to the UE. The PDCCH which schedules the PDSCH including the RAR may be transmitted by being CRC-masked with a random access (RA) radio network temporary identifier (RNTI) (RA-RNTI). The UE, which has detected the PDCCH masked with the RA-RNTI, may receive the RAR from the PDSCH scheduled by the DCI carried by the PDCCH. The UE may check whether random access response information for the preamble transmitted by the UE, i.e., Msg1, is in the RAR. Whether the random access response information for the Msg1 transmitted by the UE is in the RAR may be determined by whether there is a random access preamble ID for the preamble transmitted by the UE. When there is no response to the Msg1, the UE may retransmit the RACH preamble a predetermined number of times while performing power ramping. The UE may calculate PRACH transmission power for retransmission of the preamble based on the most recent path loss and a power ramping counter.

The UE may transmit, as an Msg3 of the random access, UL transmission through the uplink shared channel based on the random access response information. The Msg3 may include an RRC connection request and an UE identifier. As a response to the Msg3, the network may transmit an Msg4, which may be treated as a contention resolution message in DL. By receiving the Msg4, the UE may enter an RRC-connected state.

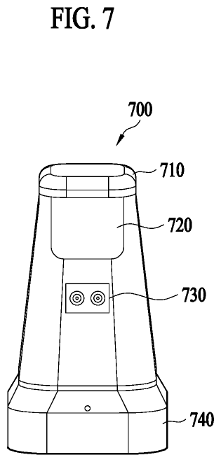

FIG. 7 is a diagram illustrating a collecting apparatus according to an example embodiment.

FIG. 7 illustrates an example of a collecting apparatus 700 for collecting an item. The collecting apparatus 700 may have a space for collecting an item therein. The space may be separated from outside. The collecting apparatus 700 may include a cover 710 to be opened upon collection of the item.

The collecting apparatus 700 may include a display 720 to provide visual information associated with item collection. The display 720 may provide text information, image information, and video information associated with item collection. Although not shown, the collecting apparatus 700 may include a sound output unit. For example, when collecting an item, the collecting apparatus 700 may display image information associated with at least one of the item and a user on the display 720 and provide a related sound through the sound output unit. For example, a video to be provided may be determined based on at least one of an age, a gender, and information on a recently purchased item of the user. Also, a video to be provided may be determined based on information associated with the item to be collected.

The collecting apparatus 700 may include a camera unit 730 to acquire at least one piece of image information. The camera unit 730 may acquire visual image information and may additionally acquire thermal image information such as an infrared image. The information acquired by the camera unit 730 may be used to identify the user and an item belonging to the user. Also, the information acquired by the camera unit 730 may be used to identify a collection time. In this disclosure, the term “collection time” refers to a point in time corresponding to an item belonging to a user is collected or a point in time corresponding to collection is performed. For example, a user holding a bottle of water may be identified based on image information and an amount of water remaining in the bottle may be identified based on image information. Thermal image information may be used along with the image information. The thermal image information may be used to acknowledge an amount of water remaining in the bottle. The collection time of the bottle may be identified based on at least one of the amount of water remaining in the bottle and a speed to which the amount of water is reduced. The collecting apparatus 700 may collect the bottle of the user based on the identified collection time and provide the user with information required for collection when collecting the bottle.

The collecting apparatus 700 may include a driver 740 for movement. The driver 740 may include at least one wheel but not be limited thereto. Various devices for moving the collecting apparatus 700 may be applicable here. The driver 740 may be controlled by a controller of the collecting apparatus 700 and used to perform autonomous driving based on a control signal of the controller.

In example embodiments of the present disclosure, waste is presented as an example of an item collected by the collecting apparatus, but the present disclosure is not limited thereto. The example embodiments of the present disclosure may be modified and applied to be collecting a target item identified through an image analysis.

As such, the collecting apparatus 700 may identify a user and an item belonging to the user through an image analysis, determine at least one of a collection time and whether to collect the item, move to a position corresponding to a result of the determining, provide information associated with the item, and collect the item.

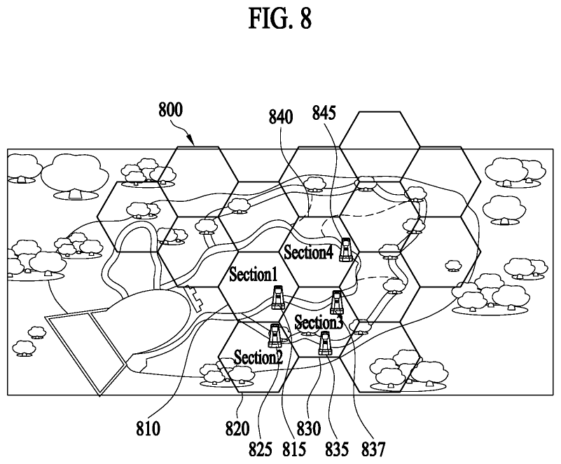

FIG. 8 is a diagram illustrating a vehicle located in a predetermined section according to an example embodiment.

Referring to FIG. 8, at least one section, for example, sections 810, 820, 830, and 840 may be set in an area 800 where a user is to be located. Collecting apparatuses 815, 825, 835, 837, and 845 may be arranged in the sections 810, 820, 830, and 840.

The collecting apparatuses 815, 825, 835, 837, and 845 may be arranged by a server and may determine arranged locations by one another through communication between the collecting apparatus 815, 825, 835, 837, and 845. Also, a collecting apparatus allocated to a section may be determined based on a number of users located in the corresponding section or a number of users carrying an item to be collected in the corresponding section. When a number of users located in a section 3, for example, the section 830 satisfies a predetermined condition, two collecting apparatus 835 and 837 may be arranged in the section 830. Also, when the number of users located in each section is changed, a collecting apparatus may be moved from one section to another section.

A position of a collecting apparatus in a section may be determined based on a density per unit area of a user located in the section. Also, a position of a collecting apparatus may be determined to minimize a sum of distances between the collecting apparatus and users located in a corresponding section. A position of a user may be determined based on at least one of image information acquired by a collecting apparatus and information acquired by at least one camera located in the area 800.

A position of a collecting apparatus may be determined to be a position corresponding to a place at which a collectable item is provided to a user. For example, a position of a collecting apparatus may be determined based on at least one a position of a store providing food and beverage for takeout and a position of a user therearound.

As such, a position of a collecting apparatus may be determined based on at least one of a user, an item, and a place for providing the item, which may increase an efficiency in utilizing a limited number of collecting apparatuses.

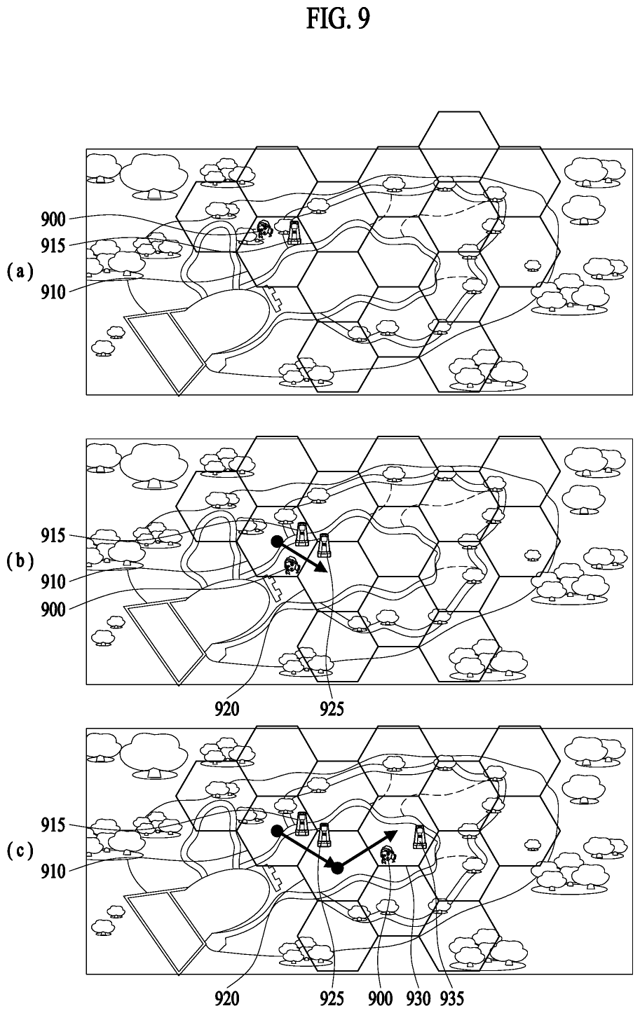

FIG. 9 is a diagram illustrating an operation of a collecting apparatus in a case in which a user moves between sections according to an example embodiment.

FIG. 9 illustrates a method of operating a collecting apparatus when a user moves in a plurality of sections.

A user 900 may carry an item to be collected and move in a plurality of sections 910, 920, and 930. Collecting apparatuses 915, 925, and 935 may move in allocated sections in correspondence to the user carrying the item to be collected. For example, when the user 900 carrying the item to be collected moves in the section 910, the collecting apparatus 915 may move in response to a position of the user 900 being changed, and identify a time at which the item is to be collected based on image information acquired at least once. In this example, when it is determined that collection is to be performed in the section 910, the collecting apparatus 915 may provide corresponding information to the user 900 and collect the item. When the user 900 moves to the section 920 adjacent to the section 910 while a time at which the collection is to be performed has not arrived, the collecting apparatus 915 may transmit at least one of information on the user 900 and information on the item by communicating with the collecting apparatus 925 of the section 920. Also, the collecting apparatus 915 may transmit, to the server, at least a portion of the information transmitted to the collecting apparatus 925 of the section 920.

The collecting apparatus 915 may identify information associated with the section 920 to which the user 900 moves and transmit a message including the information associated with the section 920 to at least one another collecting apparatus. The message may be transmitted through vehicle to vehicle (V2V) communication. In response to the message being received, the collecting apparatus 925 of the section 920 may transmit a response message to the collecting apparatus 915. Based on the received response message, the collecting apparatus 915 may provide information associated with the user 900 and the item belonging to the user 900 to the collecting apparatus 925 of the section 920. Thereafter, the collecting apparatus 925 in the section 920 may identify a collection time while moving in the section 920 based on a position of the user 900.

When the user 900 moves to another section, for example, the section 930, the collecting apparatus 925 may transmit related information to the collecting apparatus 935 of the section 930 and transmit at least a portion of the related information to a server. The collecting apparatus 935 may identify a collection time while moving to a position corresponding to the user 900 in the section 930 based on the received information.

The server may identify information associated with a movement of the user 900 and a change in the item of the user 900 and estimate a time or a place for collecting the item based on the identified information. Also, the server may provide the estimated information to a collecting apparatus, so that the collecting apparatus moves to a position corresponding to the user 900 based on the information provided from the server. The position corresponding to the user 900 may be determined based on at least one of a collection time and whether collection is to be performed. For example, when the collection time is imminent, the collecting apparatus may move to a place more adjacent to the user, so as to move based on a movement of the user.

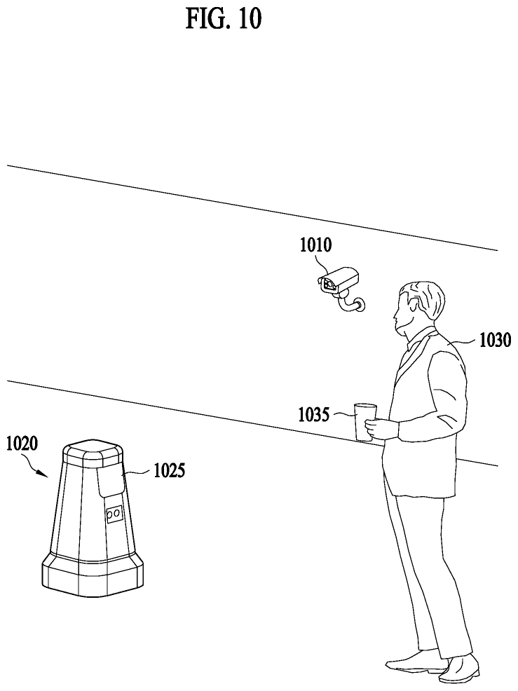

FIG. 10 is a diagram illustrating a method of collecting, by a collecting apparatus, an item according to an example embodiment.

FIG. 10 illustrates a camera 1010 connected to a server, a collecting apparatus 1020, and a user 1030.

The camera 1010 connected to the server may acquire image information associated with the user 1030 and transmit the image information to the server. The server may analyze the received image information and provide an analysis result to the collecting apparatus 1020. The camera 1010 may transmit and receive information through wireless communication with the collecting apparatus 1020.

Information acquired through the camera 1010 may include at least one of image information of a user and information associated with an item 1035. Also, position information of the user may be acquired. Based on such information, the server may determine a position to which the collecting apparatus 1020 is allocated and transmit information on a user located at a position that the collecting apparatus 1020 may not identify to the collecting apparatus 1020, so that the collecting apparatus 1020 monitors the user.

The collecting apparatus 1020 may move to a position corresponding to the user 1030 based on information acquired through a camera unit of the collecting apparatus. For example, the item 1035 of the user 1030 may be a cup filled with beverage. The collecting apparatus 1020 may determine whether to perform collection based on an amount of beverage remaining in the cup. When the amount of beverage remaining in the cup satisfies a first condition, the collecting apparatus 1020 may perform monitoring on the user 1030 while being maintained at a first distance from the user 1030. When the amount of beverage remaining in the cup satisfies a second condition less than the first condition, the collecting apparatus 1020 may perform an operation related to collection while being maintained at a second distance from the user 1030, the second distance which is shorter than the first distance. The operation related to collection may include providing information related to the collection to a display 1025. The information related the collection may include information inquiring whether to collect the item. Also, information provided in the example embodiment may be determined based on at least one of the user 1030 and the item 1035. For example, the provided information may be determined based on information associated with at least one of an age, a gender, an item purchase history, and moving line information of the user 1030.

The collecting apparatus may identify a type of the item belonging to the user through an image analysis. When an item is identified as an item for waste collection through the image analysis, a time at which the waste collection is to be performed may be determined. For example, when the beverage in the item 1035, which is a cup, is reduced to be less than or equal to a predetermined amount, a determination to collect the item may be made. Accordingly, the collecting apparatus 1020 may move to a corresponding position to monitor the user 1030 and provide information related to the collection as necessary. Also, when an amount of beverage in the cup 1035 satisfies a predetermined condition (e.g., 30% to 50%), the collecting apparatus 1020 may predict that collection is to be performed, change a period for acquiring image information of the user, move to a position corresponding to the user, and perform monitoring. Thereafter, when it is determined to perform the collection, the collecting apparatus 1020 move to a position to be closer to the user and provide information related to the collection to the user. Also, when it is determined that the item of the user is not to be collected through the image analysis, the collecting apparatus 1020 may provide information associated with the user to the server or another collecting apparatus and may set a longer monitoring period for the user carrying the item. Although the description is given of the monitoring performed based on an amount of beverage in the cup as an example, embodiments may be commonly applied to an item to be consumed by a user. For example, in a case of food, as a user consumes the food, an amount of the food may decrease. In this example, a collecting apparatus may identify the decrease in the amount of the food based on image information and determine a collection time.

As such, a collecting apparatus may identify a user and an item based on information acquired through a camera connected to a server and information acquired by the collecting apparatus and perform a corresponding operation, thereby determining whether to collect the item and a collection time with increased accuracy.

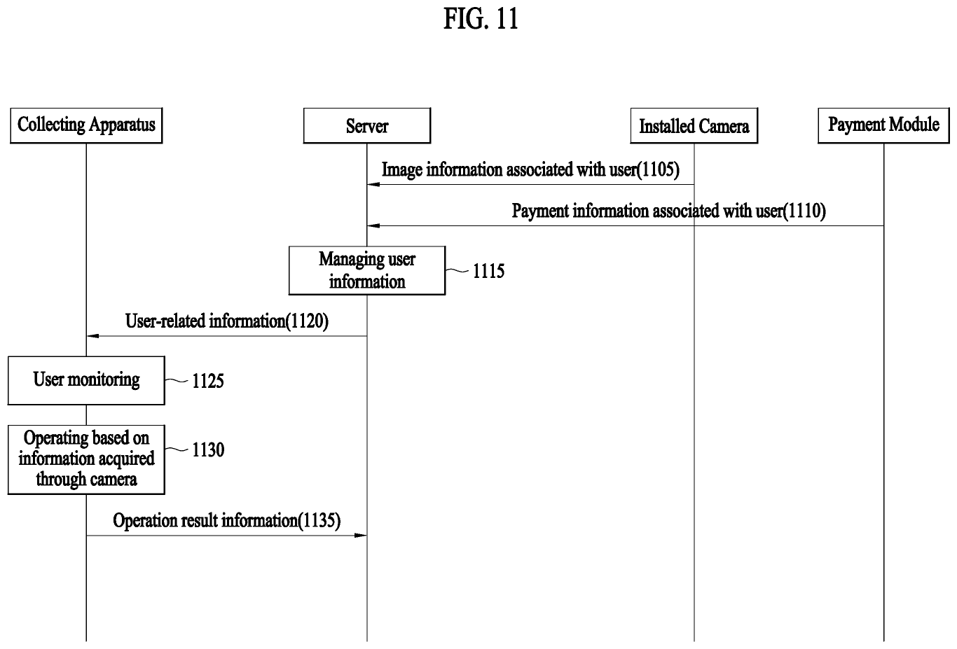

FIG. 11 is a flowchart illustrating information exchanged between item collecting systems and operations performed by devices based on the information.

Referring to FIG. 11, a collecting system may include a collecting apparatus, a server, an installed camera, and a payment module. Depending on an example, some components may be omitted.

The collecting apparatus may monitor a user based on at least one of a control of the server and a control signal of an operating device in association with the collecting device, move to a position corresponding to the user, provide information related to item collection to the user, and collect an item.

The server may communicate with another component and manage information associated with at least one of the user and the item based on information received from the other component.

The installed camera may be a camera installed in at least one of areas in which the collecting apparatus is operated. The installed camera may acquire the information associated with at least one of the user and the item and provide the acquired information to the server.

The payment module may be a node for providing information associated with the user purchases the item in a place related to an area in which the collecting apparatus is operated. When the user purchases an item predicted to be collected, the server may acquire payment information from the payment module and provide the payment information to the collecting apparatus, thereby supporting an operation of the collecting apparatus.

In operation 1105, the installed camera may provide image information associated with the user to the server. For example, the installed camera may acquire image information associated with the user and the item and provide the acquired image information to the server.

In operation 1110, the server may receive payment information associated with the user from the payment module. The payment information may include information associated with the item purchased by the user in an area managed by the server. The server may additionally manage information associated with the item predicted to be collected.

In the example embodiment, operation 1105 and operation 1110 may be selectively performed, and it is obvious that collection to the server can be performed while the below-described operations are being performed.

In operation 1115, based on at least one of the received information, the server may identify the user based on the image information associated with the user, and track and manage user information based on image information to be collected in association with the identified user. For example, the server may assign identification information associated with the user and manage information associated with an item belonging to the user, history information associated with the user and item purchase information of the user. Also, the server may manage position information of the user and information for determining a collection time of the item. Through this, information for item collection may be provided to the collecting apparatus.

In operation 1120, the server may provide information associated with the user to the collecting apparatus. In this disclosure, the “information associated with a user” may also be referred to as “user-related information.” The server may provide the information associated with at least one of the user and the item to the collecting apparatus. The information may include at least one of the position information of the user, whether the item is to be collected, a monitoring period, and information on a predicted collection time of the item. The collecting apparatus may operate based on the information received from the server. The information transferred from the server to the collecting apparatus may include information on a position of a hand acquired from the image information of the user.

In operation 1125, the collecting apparatus may perform user monitoring based on the received information. The collecting apparatus may perform the user monitoring by moving to a position corresponding to the user based on the position information of the user. The position corresponding to the user may be determined based on a distance to which the collecting apparatus is able to acquire the image information of the user. The user-related information may include information on at least two users. The collecting apparatus may monitor at least two users based on the received information. A position of the collecting apparatus may be determined to be a position at which the collecting apparatus is able to monitor two users.

In operation 1130, the collecting apparatus may acquire user information through a camera and perform a corresponding operation based on the acquired user information. For example, the collecting apparatus may acquire image information of a corresponding user based on received information and acquire user information and information associated with an item belonging to the user based on the acquired image information. The user information may include information such as a gender and an age of the user. The information associated with the item may include information on whether the item is to be collected and a predicted collection time of the item. When it is determined that the item is to be collected based on the acquired information, the collecting apparatus may move to a position at which the collecting apparatus is able to provide information to the user and provide the user with information requesting collection of the item. The information requesting collection of the item to be collected may include information associated with a target item, and corresponding information may be additionally provided based on at least one of the user and the item. For example, a corresponding video may be provided based on user information such that the user feels friendly. In this instance, the user information may be provided from the server or identified based on the image information acquired by the collecting apparatus.

Also, the information provided in the example embodiment may include additional advertisement information determined based on a current position, the information associated with the item, and the user information. For example, information on a store corresponding to the user, adjacent to a current position, and selling goods corresponding to other users associated with the item may be provided to the user.

In operation 1135, the collecting apparatus may report operation result information to the server. For example, the collecting apparatus may report information on whether the collection has been performed to the server. Also, when the user refuses the collection, the collecting apparatus may provide related information to the server. When the user refuses collection of a specific item, the server may provide related information to another collecting apparatus.

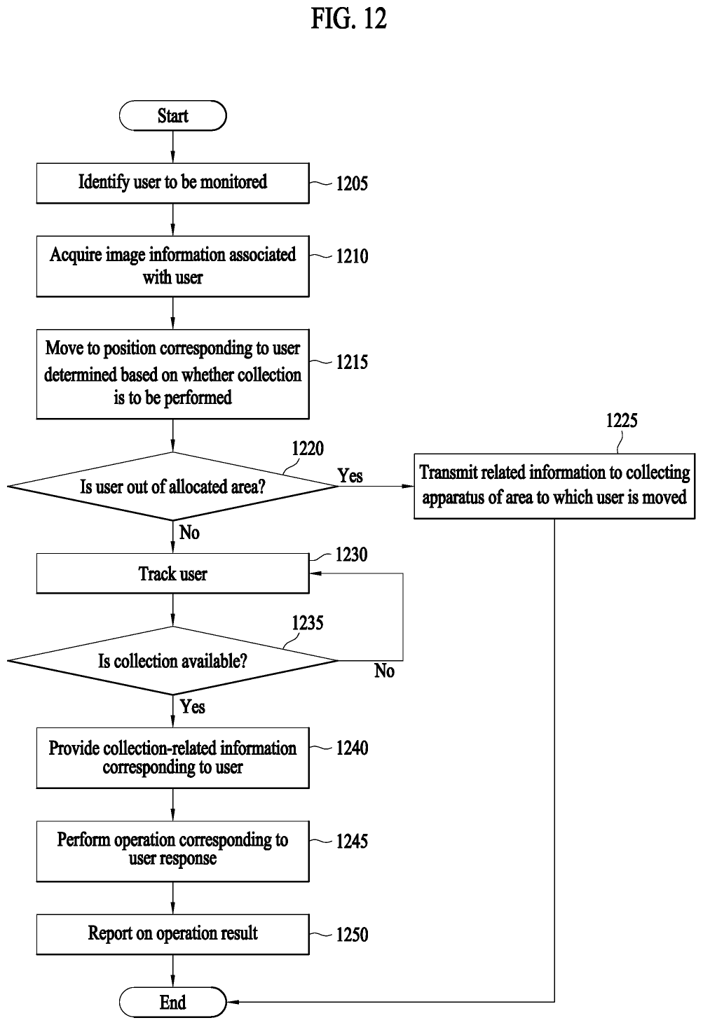

FIG. 12 is a flowchart illustrating a method of collecting, by a collecting apparatus, an item according to an example embodiment.

FIG. 12 illustrates a method in which a collecting apparatus monitors a user and perform a corresponding operation.

In operation 1205, the collecting apparatus may identify a user to be monitored. The collecting apparatus may identify the user to be monitored based on information received from a server. When separate information is not provided from the server, the collecting apparatus may identify the user to be monitored based on information acquired through a camera unit. The user to be monitored may be at least one user. Whether to perform monitoring may be determined based on whether a user carries an item to be collected.

In operation 1210, the collecting apparatus may acquire image information associated with the user to be monitored. The collecting apparatus may acquire the image information to acquire information on an item belonging to the user to be monitored. A frequency of performing the monitoring may be determined based on at least one of a type of a target item and a predicted collection time of the target item. For example, when the item is carried by the user for a relatively short period of time and needs to be collected quickly, information on the item may be monitored more frequently. In addition, the collecting apparatus may predict a collection time at which collection is to be performed and monitor the information on the item more frequently when the collection time is imminent. Also, the collecting apparatus may identify information associated with at least one of whether to perform collection and a predicted collection time based on the acquired information.

In operation 1215, when the item is to be collected, the collecting apparatus may move to a position corresponding to the user. Also, the collecting apparatus may move to a position determined based on whether the collection is to be performed and the predicted collection time. The determined position may be a position at which information on the user is collected with increased accuracy.

In operation 1220, the collecting apparatus may verify whether the user is out of an area allocated to the collecting apparatus. For example, the collecting apparatus may be allocated to a specific area by the server and perform an operation related to the collection while monitoring users in the corresponding area.

When the user is out of the area allocated to the collecting apparatus, in operation 1225, the collecting apparatus may identify information on an area to which the user moves and provide information associated with the user to a collecting apparatus of the area. The information associated with the user may include at least one of information acquired by the collecting apparatus and information received from the server in association with the user and the item. In one example, the collecting apparatus may transmit corresponding information to a specific collecting apparatus. In another example, the collecting apparatus may broadcast corresponding information such that a neighboring collecting apparatus receives the corresponding information.

When the user is within the area allocated to the collecting apparatus, in operation 1230, the collecting apparatus may track the user while being maintained at a predetermined distance from the user. The collecting apparatus may consistently perform the user monitoring while tracking the user.

In operation 1235, the collecting apparatus may verify whether the collection of the item is available based on user monitoring information. When a predetermined condition is satisfied, the collecting apparatus may determine that the collection of the item is available. The predetermined condition may be determined based on at least one of a type of an item, user information, weather information, a time in which the collecting apparatus tracks the user, and a position of the user. Even in a case of the same item, when there is a different element, the collecting apparatus may verify whether the collection is available based on a different condition.

When the collection is unavailable, the collecting apparatus may continually track the user. When a time in which the collecting apparatus tracks is prolonged, the collecting apparatus may be controlled to provide collection-related information to the user.

When the collection is available, in operation 1240, the collecting apparatus may provide collection-related information corresponding to the user. The collecting apparatus may provide the user with information inquiring whether the collection is to be performed. The collection-related information may be determined based on at least one of user information and item information. For example, provided information may include advertisement information determined based on information on an age of a user and an item, and may also include sound source and image information which may be preferred by the user based on an age and a gender of the user. Also, the collecting apparatus may open a cover during provision of the information such that the user easily delivers the item to the collecting apparatus.

In operation 1245, the collecting apparatus may identify a user response of corresponding to the information provided to the user and perform an operation corresponding to the user response. The user response may include at least one of delivering the item to the collecting apparatus, providing information indicating that the collection is unnecessary, and providing information indicating that the collection is to be performed later. The collecting apparatus may use a camera to identify such information and may also use a microphone to identify such information. The corresponding operation may include at least one of collecting a delivered item and outputting information corresponding to the information provided from the user. When the user provides the information indicating that the collection is unnecessary to the collecting apparatus, the collecting apparatus may store the information and not determine whether to collect the item when performing the user monitoring thereafter. When the information indicating that the collection is to be performed later is received, the collecting apparatus may continually perform monitoring for collecting the item.

In operation 1250, the collecting apparatus may report, to the server, at least one of a previous operation result and determination information of the collecting apparatus therefor. Also, the collecting apparatus may transfer at least a portion of the above information to another collecting apparatus. The server may manage the user information and the item information based on the received information and provide the information to another collecting apparatus.

A time during which the collecting apparatus waits for the user response or consistently tracks a specific user may be adaptively determined. For example, when a number of users located in an area allocated to the collecting apparatus or users carrying the item to be collected is greater than or equal to a predetermined value, the collecting apparatus may set the time during which the collecting apparatus waits for the user response or consistently tracks a specific user, to be relatively short. When the number is less than the predetermined value, the collecting apparatus may set the time to be relatively long. Also, a response waiting time or a user tracking time may be determined in inverse proportion to the number of users. For example, as the number of users increases, a number of users to be monitored by the collecting apparatus may increase. In this example, a period of time in which the collecting apparatus performs an operation in conjunction with a specific user may be reduced. Through this, by using the same number of collecting apparatuses, services may be provided to more users.

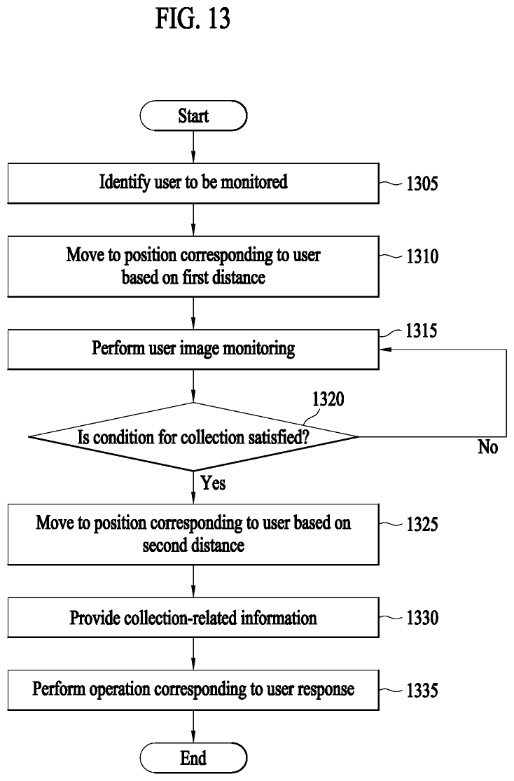

FIG. 13 is a flowchart illustrating a method of collecting, by a collecting apparatus, an item according to an example embodiment.

FIG. 13 illustrates a method of in which a collecting apparatus performs a collection-related operation while being maintained at a predetermined distance from a user to be monitored.

In operation 1305, the collecting apparatus may identify a user to be monitored for collection. The collecting apparatus may identify the user to be monitored based on at least one of information received from a server and information acquired by the collecting apparatus.

In operation 1310, the collecting apparatus may move to a position corresponding to the identified user based on a first distance. The collecting apparatus may move in correspondence to a position of the user within the first distance. The first distance may be determined based on a position at which the collecting apparatus is able to accurately monitor the user and an item belonging to the user. When one collecting apparatus monitors a plurality of users, the collecting apparatus may use different methods to determine the first distance. In this example, the collecting apparatus may determine the distance using a scheme of maintaining a distance between two users at a position satisfying a predetermined condition in simultaneous consideration of positions of the plurality of users. In the example embodiment, the first distance may be determined to be 1.5 meters (m) to 4.5 m but not be limited thereto.

In operation 1315, the collecting apparatus may monitor at least one of the user and the item belonging to the user based on image information corresponding to the user at a position corresponding to the user in consideration of the first distance. The collecting apparatus may use a camera of the collecting apparatus to monitor at least one of the user and the item belonging to the user at the first distance. The collecting apparatus may monitor information on whether the item is to be collected. When the item is a container, the collecting apparatus may monitor an amount of contents remaining in the container. When the item is food, the collecting apparatus may monitor a size of the item.

In operation 1320, the collecting apparatus may determine whether the item to be monitored satisfies a condition for collection. The condition for collection may include a case in which the amount of contents remaining in the container is less than or equal to a predetermined amount and a case in which the size of the food is reduced to be less than or equal to a predetermined size or proportion. Also, the condition for collection may include a verification that the item is predicted to be collected. For example, in a case in which a previous user has a history of requesting collection of the item when the item satisfies a predetermined condition, the collecting apparatus may learn the condition for collection using such information. Also, the collecting apparatus may determine that the condition for collection is satisfied when a probability of the user requesting the collection of the item is greater than or equal to a predetermined value based on the information learned by the collecting apparatus. The condition for collection may be determined differently based on a number of users to be monitored by the collecting apparatus. For example, when the number of users to be monitored by the collecting apparatus is relatively large, the condition for collection may be determined strictly. By strictly determining the condition for collection, a number of times that the collection-related operation is to be performed may be reduced. Through this, more users may be monitored and items of the users may be collected by using a limited number of collecting apparatuses.

When a user satisfying the condition for collection is absent, the collecting apparatus may continually monitor a user and an item belonging to the user.

When a user satisfying the condition for collection is present, in operation 1325, the collecting apparatus may move to a position corresponding to the user based on a second distance. Here, the second distance may be shorter than the first distance, and may be a distance for providing collection information to a user. For example, when a user and the collecting apparatus are located based on the second distance, the user may easily acquire visual and auditory information provided by the collecting apparatus and deliver an item belonging to the user to the collecting apparatus. In the example embodiment, the second distance may be determined to be 0.2 m to 2 m but not be limited thereto.

In operation 1330, when the collecting apparatus determines that the item is to be collected from the user, the collecting apparatus may provide collection-related information to the user. The collecting apparatus may sense information related to a hand of the user from acquired user-related image information. When a number of items held by the hand of the user increases, the collecting apparatus may provide the collection-related information to the user and perform an operation of collecting the item. Providing the collection-related information to the user may include opening a cover for collection to allow the user to provide the item to the collecting apparatus without providing separate information to the user, in addition to making a separate query to the user.

In operation 1335, the collecting apparatus may perform an operation corresponding to a user response based on information provided to the user in advance.

As such, by varying a position of the collecting apparatus, the user may be monitored with increased accuracy. Also, the collecting apparatus may quickly approach the user when the collection is required, which may increase a usability.

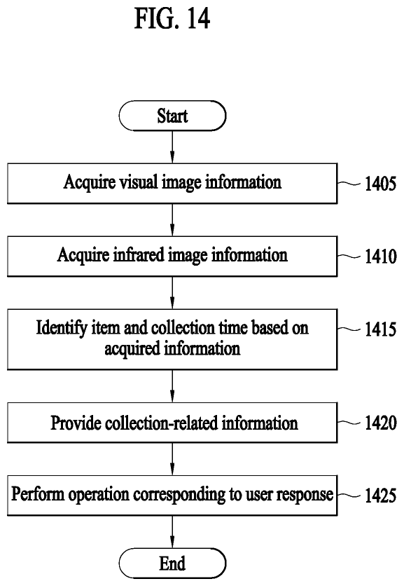

FIG. 14 is a flowchart illustrating a method of collecting, by a collecting apparatus, an item based on at least one piece of image information according to an example embodiment.

FIG. 14 illustrates a method in which a collecting apparatus determines whether an item is to be collected.

In operation 1405, the collecting apparatus may acquire visual image information associated with a user and an item belonging to the user. The visual image information may be acquired through a camera which is commonly used. The collecting apparatus may identify information associated with the user and information associated with the item based on image information and learning information. The information associated with the item may include information for determining whether the item is to be collected. For example, in a case in which the user is holding many items with hands, in a case in which the item is food and beverage in a container and only the container remains due to reduction of contents, and in a case in which the item is a leaflet and the user has not seen the item for at least a predetermined period of time, the collecting apparatus may determine that the item is to be collected. Also, predetermined identification information may be included in an item sold in an area associated with the collecting apparatus, so that the collecting apparatus determines whether the item is to be collected based on the identification information. For example, an image such as a logo may be attached to a container of a selling product, so that the collecting apparatus verifies whether the corresponding item is to be collected based on information on the image.

In operation 1410, the collecting apparatus may acquire infrared image information. On an infrared image, temperature information of each component may be acquired. The infrared image is merely an example and thus, various methods to acquire temperature information of a specific object may be applied. The collecting apparatus may verify whether an item is to be collected based on acquired temperature information of the item. For example, when a temperature of contents in a container is different from an outside temperature, an amount of contents remaining in the container may be determined based on acquired temperature information. A portion of information acquired in operation 1405 and operation 1410 may be acquired selectively.

In operation 1415, the collecting apparatus may identify an item to be collected and a collection time based on at least a portion of the acquired information. The collecting apparatus may identify the item to be collected and the collection time by additionally using learned information, which may be performed based on at least one of the example embodiments described in the present disclosure.

In operation 1420, the collecting apparatus may provide collection-related information to the user based on the identified information. In operation 1425, the collecting apparatus may perform an operation corresponding to a sensed user response.

As such, accuracy of a collection-related operation may be increased by identifying the item to be collected and the collection time based on a variety of types of image information.

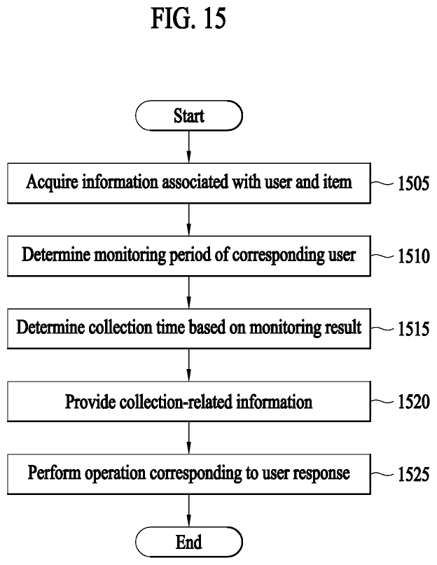

FIG. 15 is a flowchart illustrating a method of, collecting, by a collecting apparatus, an item based on information associated with an item and a user according to an example embodiment.

FIG. 15 illustrates a method of performing, by a collecting apparatus, monitoring on a user.

In operation 1505, the collecting apparatus may acquire information associated with a user and an item. Such information may be provided from a server and acquired through a camera of the collecting apparatus. Also, the server may designate the user to be monitored to the collecting apparatus.

In operation 1510, the collecting apparatus may determine a monitoring period of the user. The monitoring period may be determined based on at least one of user information, a number of users monitored by the collecting apparatus, and whether a collection time of an item belonging to the user is imminent. When a number of users to be monitored is relatively large, a relatively long monitoring period may be set. When a necessity for collection based on the user information is high, a relatively short monitoring period may be set. When the collection time is imminent, a relatively short monitoring period may be set.

In operation 1515, the collecting apparatus may determine a point in time at which the collection is to be performed based on a monitoring result. In operation 1520, the collecting apparatus may provide collection-related information based on a collection-related operation. In operation 1525, based on a user response corresponding to a collecting operation, the collecting apparatus may perform an operation corresponding thereto.

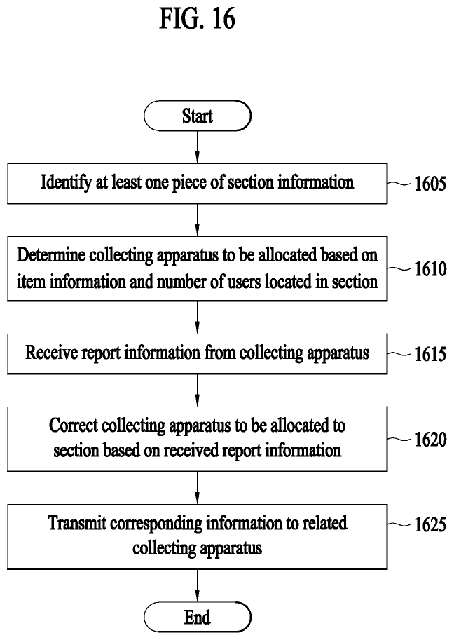

FIG. 16 is a flowchart illustrating a method in which a server of a collection system allocates a collecting apparatus to a section and controls the collecting apparatus according to an example embodiment.

Referring to FIG. 16, the server of the collection system may identify section information, determine a collecting apparatus to be allocated to a section, and update allocation information through communication with the collecting apparatus.

In operation 1605, the server may identify at least one piece of section information. At least one section may be set in an area in which the collection system is operated. A size of a section may be variable. The section may be divided based on a number of users located in the section.

In operation 1610, the server may determine a collecting apparatus to be allocated to the identified section. The server may determine at least one of types and a number of allocated collecting apparatuses based on at least one of item information and the number of users located in the section. For example, when the number of users and items increases in the section, the server may increase a number of allocated collecting apparatuses. Also, the server may set an operation scheme of the collecting apparatus differently based on the number of users and items in the section. For example, when the number of users and items increases in the section, a period in which the collecting apparatus monitors one user may be set to be relatively long or a time during which the collecting apparatus is on standby for one user may be set to be relatively short.

In operation 1615, the server may receive information associated with an operation of the collecting apparatus from the collecting apparatus. The information associated with the operation may include at least one of image information acquired from the area, information on a user response, and information associated with collection of the collecting apparatus.

In operation 1620, the server may determine the number of collecting apparatuses to be allocated to a specific section based on the information reported from the collecting apparatus. For example, when item collection has been sufficiently performed on users in a specific section, the number of collecting apparatuses allocated to the section may be reduced. When it is determined that more collecting apparatuses are required, the number of collecting apparatus allocated to the section may be increased.

In operation 1625, the server may provide allocated section information to the collecting apparatus based on at least a portion of information determined in the preceding operation.

Also, the server may identify the number of users located in a specific section and allocate the collecting apparatus to each section based on the identified number of users. In the example embodiment, the number of users may be determined to be the number of users carrying items to be collected, but not be limited thereto. The number of collecting apparatuses allocated to each section may be determined based on simply the number of users. Also, in a case of a section in which a number of users less than or equal to a predetermined number are located, the collecting apparatus may not be allocated to the section, the allocated collecting apparatus may be set to operate in an idle mode, or an allocated section may be changed such that the collecting apparatus is allocated to another section. The idle mode may include switching the collecting apparatus into a charging mode or waiting instead of performing autonomous driving.

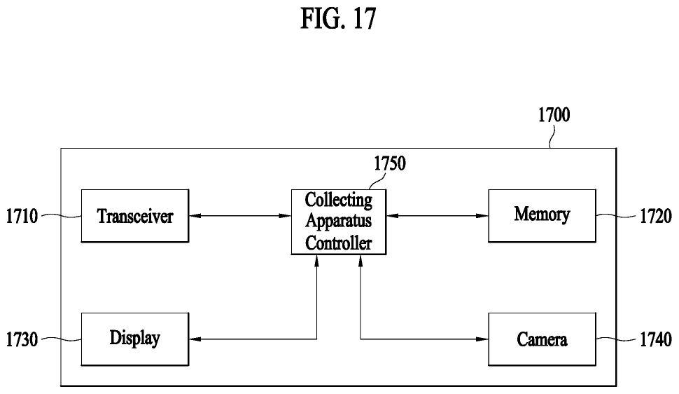

FIG. 17 is a diagram illustrating a collecting apparatus of the present disclosure.

Referring to FIG. 17, a collecting apparatus 1700 may include any one or combinations of a transceiver 1710, a memory 1720, a display 1730, a camera 1740, and a controller 1750 that controls the collecting apparatus 1700.

The transceiver 1710 may communicate with at least one of a server and another collecting apparatus. For example, the transceiver 1710 may communicate with a camera associated with the server.

The transceiver 1710 may include a device for performing wireless communication.

The memory 1720 may store at least one of information transmitted and received through the transceiver 1710 and information input to the collecting apparatus 1700. In addition, data and information processed by a control of the controller 1750 or separate learning may also be stored in the memory 1720. The memory 1720 may include a non-volatile memory and may include a medium capable of storing information electronically.

The display 1730 may visually provide information associated with an operation of the collecting apparatus 1700. For example, when the collecting apparatus 1700 suggests collection of an item to a user, related information may be displayed on the display 1730. Also, the display 1730 may be provided together with a speaker (not shown) to provide sound information to a user.

By using the camera 1740, the collecting apparatus 1700 may acquire image information. The camera 1740 may include a camera for capturing a general image and an infrared camera for acquiring temperature information.

The controller 1750 may control other components of the collecting apparatus 1700 and may include at least one processor. The controller 1750 may control the collecting apparatus 1700 to perform at least one operation performed by the collecting apparatus in the example embodiments.

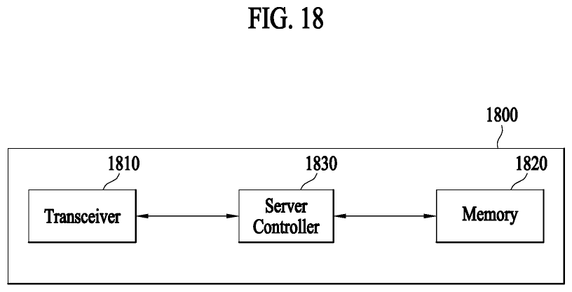

FIG. 18 is a diagram illustrating a server of the present disclosure.

Referring to FIG. 18, a server 1800 may include any one or combinations of a transceiver 1810, a memory 1820, and a controller 1830 that controls the server 1800.

The transceiver 1810 may communicate with at least one of a server and a camera associated with the server. Also, the transceiver 1810 may include a device for performing wireless communication.

The memory 1820 may store at least one of information transmitted and received through the transceiver 1810 and information input to the server 1800. In addition, data and information processed by a control of the controller 1830 or separate learning may also be stored in the memory 1820. The memory 1820 may include a non-volatile memory and may include a medium capable of storing information electronically.

The controller 1830 may control other components of the server 1800 and may include at least one processor. The controller 1830 may control the server 1800 to perform at least one operation performed by the server in the example embodiments.

According to example embodiments, a robot that communicates with an information & communication technology (ICT) infrastructure configured in a specific area, identifies a user based on image information and other auxiliary information, monitors a position of the user, and monitors an item to be collected while moving to a position corresponding to the user through autonomous driving is disclosed. The robot may identify an item to be collected, identify a time at which the collection is to be performed, move to a position corresponding to a user based on the time. Also, in response to a determination that the collection is required, the robot may provide related information to the user and collect the item. As such, an autonomous driving robot may determine states of a user and an item and collect the item at a time when collection is required, thereby providing the user with increased usability.

In addition, when collecting the item, at least one of visual output information and auditory output information determined based on information associated with at least one of the user and the item may be provided to reduce user's uncomfortableness to the autonomous driving robot.

Also, the image information acquired by the robot may be provided to a server, so that the server collects hygienic information and security information of a specific area.

The present disclosure and drawings have been described with respect to the example embodiments, although specific terms are used, it is only used in a general sense to easily explain the technical details of the present disclosure and help the understanding of the invention, It is not intended to limit the scope of the invention. It will be apparent to those skilled in the art that other modifications based on the technical idea of the present disclosure can be carried out in addition to the example embodiments disclosed herein.

What is claimed is:

1. A method for a collecting apparatus, the method comprising:
identifying a user and an item associated with the user;
obtaining image information associated with the user;
identifying that the item is to be collected based on the image information;
causing the apparatus to move to a location corresponding the user based on the identifying that the item is to be collected; and
providing, to the user, information associated with the item to be collected.

2. The method of claim 1, further comprising:
receiving information from a server,
wherein the user is identified based on the information received from the server.

3. The method of claim 1, wherein the image information includes at least one of information about the user or information about the item.

4. The method of claim 1, wherein a first distance between a location of the apparatus and the location of the user defines a first condition,
wherein the image information is obtained at a location that is at a second distance from the user that satisfies a second condition, and
wherein the first distance is shorter than the second distance.

5. The method of claim 4, further comprising:
causing the apparatus to move to the location, when the identified item satisfies a predetermined condition and when distance of the location of the apparatus from the location of the user satisfies the second condition.

6. The method of claim 1, wherein the image information includes thermal image information, and wherein the method further comprises:
performing the identifying that the item is to be collected based on a consumed amount of the item identified based on the thermal image information of the image information.

7. The method of claim 1, further comprising:
receiving payment information corresponding to the item; and
performing the obtaining the image information based on the payment information.

8. The method of claim 1, further comprising:
identifying information on a section within which the apparatus functions to collect items;
transmitting, when the user moves outside the section, information associated with the user and the item to another collecting apparatus on a channel for communication between apparatuses.

9. The method of claim 1, further comprising:
determining a frequency of obtaining the image information and a time at which the information associated with the item to be collected is provided based on a number of identified users.

10. The method of claim 1, further comprising:
transmitting, to a server, information on a user response corresponding to the provided information.

11. The method of claim 1, further comprising:
performing the identifying that the item is to be collected further based on learned information of a history associated with operation of the collecting apparatus.

12. The method of claim 2, wherein the information received from the server includes at least one of user identification information, information for the location of the user, information associated with a position of a hand of the user, information of the item belonging to the user, or history information associated with a behavior of the user.

13. The method of claim 1, wherein the identifying that the item is to be collected comprises identifying that a predetermined marking is on the item.

14. A collecting apparatus comprising:
a transceiver configured to communicate with another node;
a driving mechanism configured to mode thee apparatus; and
a controller configured to control the transceiver and driving mechanism, wherein the controller is configured to:
identify a user and an item associated with the user;
obtain image information associated with the user;
identify that the item is to be collected based on the image information;
control the driving mechanism to cause the apparatus to move to a location corresponding to the user based on the identify that the item is to be collected; and
provide, to the user, information associated with the item to be collected.

15. A server comprising:
a transceiver configured to communicate with another node; and
a controller configured to:
control the transceiver to transmit first information associated with a user and an item associated with the user to a collecting apparatus
control the transceiver to receive second information associated with the user and collection of the item from the collecting apparatus,
wherein the transmitted first information permits the collecting apparatus to collect the item based on image information acquired based on the first information.
